(19) United States
(12) Patent Application Publication
(10) Pub. No.: US 2010/0275185 A1
(43) Pub. Date: Oct. 28, 2010

(54) System and Method for High Performance Coverage Analysis

(76) Inventors: Felix Burton, San Mateo, CA (US); Tomas Evensen, Foster City, CA (US); Brian Nash, Swindon (GB)

Correspondence Address: FAY KAPLUN & MARCIN, LLP, 150 BROADWAY, SUITE 702, NEW YORK, NY, 10038, US

(21) Appl. No.: 12/429,501

(22) Filed: Apr. 24, 2009

(51) Int. Cl. G06F 9/44; G06F 9/45

(52) U.S. Cl. 717/130; 717/145

(57) ABSTRACT

A system and method for inserting at least one instrumentation point into a program at a first location, executing the program and removing the instrumentation point from the program when the executing program reaches the instrumentation point. The system and method further recording the at least one instrumentation point in a record when the instrumentation point is removed from the program.

### BACKGROUND

In software engineering, performance analysis, or simply “profiling”, may be described as the investigation of a program's behavior using information gathered once the program executes. The goal of performance analysis may be to determine which parts of a program to optimize for speed or memory usage. In addition, the term “instrumentation” refers to the ability to monitor and/or measure a performance level of a computing programming application, such as diagnosing errors and writing trace information. Accordingly, instrumentation may be in the form of code instructions that monitor specific components in a system. Therefore, when an application contains instrumentation code, it may be managed using a management tool.

Instrumentation is necessary to review the performance of the application. Various instrumentation approaches may be of two types, source instrumentation and binary instrumentation. Furthermore, instrumentation may refer to the ability of an application to incorporate code tracing, debugging, exception handling, performance counters, and event logs.

There are many applications where software needs to exert real-time control. Examples of this are control systems for aircraft, factories, automobiles, printers, broker transaction computers, etc. A typical implementation would have a dedicated target computing device that controls the aircraft, factory, etc., with target software on the target computing device. This computing device could be uplinked via a TCP-IP Ethernet link, linked, networked or otherwise connected to a host computer. This could be a Unix-based workstation or a Windows-based PC, for example. The host can be used to download and configure the software which will run on the target computer, and customize such software.

Within a conventional computer system, coverage analysis may be typically performed by inserting extra code into an application (e.g., executable program). This application then updates code coverage data either by compiling with special flags, or by patching the executable file in order to insert the extra code. Accordingly, this conventional computer system requires the application to be compiled in a special manner, distinct from how the application will run in a live system.

### SUMMARY OF THE INVENTION

A method for inserting at least one instrumentation point into a program at a first location, executing the program and removing the instrumentation point from the program when the executing program reaches the instrumentation point.

A system having an insertion module inserting at least one instrumentation point into a program at a first location, an execution module executing the program and a removing module removing the instrumentation point when the executing program reaches the instrumentation point.

A memory including a set of instructions executable by a processor. The set of instruction being operable to insert at least one instrumentation point into a program at a first location, execute the program, remove the instrumentation point from the program when the executing program reaches the instrumentation point and record the at least one instrumentation point in a record when the instrumentation point is removed from the program.

### BRIEF DESCRIPTION OF THE DRAWINGS

FIG. 1 shows an exemplary embodiment of a system for providing a coverage analysis tool according to the exemplary embodiments of the present invention.

FIG. 2 shows an exemplary embodiment of a method for providing a coverage analysis tool according to the exemplary embodiments of the present invention.

### DETAILED DESCRIPTION

The exemplary embodiments of the present invention may be further understood with reference to the following description and the appended drawings, wherein like elements are referred to with the same reference numerals. The present invention relates to instrumentation of software performance, in particular real-time, embedded or multi-tasking software running on a target computer being monitored by a separate, host computer. As used herein, target and host computer could refer to target and host programs or suites of programs running on a single computer. Specifically, the exemplary embodiments of the present invention relate to systems and methods for generating software code coverage using dynamic code instrumentation. In other words, the exemplary embodiments allow for the replacement of instructions on a host computer while performing incremental instrumentation on the code in runtime.

As will be described below, the exemplary embodiments of the present invention describe methods to execute high performance coverage analysis of an application while minimizing performance overhead (e.g., use of additional code) and footprint overhead (e.g., portion of computing resources required by a software application). In general, the exemplary embodiments of the present invention utilize dynamic instrumentation (e.g., via sensorpoints or other mechanisms) in order to keep track of program code as the code is being executed. A sensorpoint may be, for example, an instrumentation point inserted into a program code, thereby allowing software developers to perform diagnostic applications on the code. However, the present invention is not limited to using sensorpoints, but may be implemented using any mechanism that can dynamically instrument a program. Furthermore, an instrumentation point may be described as an address in a program code in order to detect which specific portions of the code have been reached (e.g., have been executed). The instrumentation point may be inserted into the program code in any number of different ways, such as by inserting an instruction generating an exception, by inserting a branch/call instruction, by using special hardware, etc. As will be described in greater detail below, the exemplary embodiments may serve as a coverage analysis tool. Furthermore, since there is no need for the program to be compiled in any special manner, the tool may perform coverage analysis for safety critical applications, such as, for example, AE653 or DO-178 applications.

Dynamic program analysis may be described as an analysis of computer software performed with executing programs built from that software on a real or virtual processor. As opposed to dynamic program analysis, analysis performed without executing programs is referred to as static code analysis. Dynamic program analysis tools may require loading of special libraries or even recompilation of program code. For dynamic program analysis to be effective, the target program must be executed with sufficient test inputs to produce interesting behavior. Use of software testing techniques such as code coverage helps to ensure that an adequate slice of the program's set of possible behaviors has been observed.

The exemplary embodiments will be described with reference to dynamic instrumentation performed on an application program, such as user code. However, those skilled in the art will understand that the exemplary embodiments of the present invention may be implemented as part of an operating system, or for any situation where a group of applications share a common stack-based memory. According to the exemplary embodiments of the present invention, the term memory may include, but is not limited to, any writeable medium that may be utilized by the application, such as, for example, RAM memory, disk memory, flash memory, bubble memory, any other volatile or non-volatile type of memory, etc. As will be described in greater detail below, the dynamic instrumentation may be performed on a target device by a host device. Alternatively, it should be noted that the coverage analysis may be performed within the host device by the host device.

According to the exemplary embodiments of the present invention, an instrumentation point may be described as a location within the computer program at which instrumentation code is inserted. Specifically, a computer program may be a composition of one or more identifiable code portions such as functions, procedures, routines, basic blocks, etc. Each of these code portions, or functions, may become a potential instrumentation point. The exemplary embodiments described herein provide systems and methods for using dynamic instrumentation to keep track of which code portions have been executed. When an instrumentation point is entered, it may be recorded and then may be removed. It should be noted that since any code without instrumentation points is guaranteed to have been executed, it may not be necessary to record that an instrumentation was entered.

As will be described in further detail below, instrumentation may be performed in an incremental fashion. Specifically, instrumentation points may first be entered on function entries. If the instrumentation point is encountered, the instrumentation process may instrument one or more conditional branches within the function. Therefore, the instrumentation points may only be executed once for each branch for the life of the computer program. In addition, the embodiments do not require the computer program to be compiled in any special manner from how the program will run in a live system. Furthermore, implementing the exemplary embodiments of the present invention may allow for effective coverage analysis to be achieved with very low performance overhead.

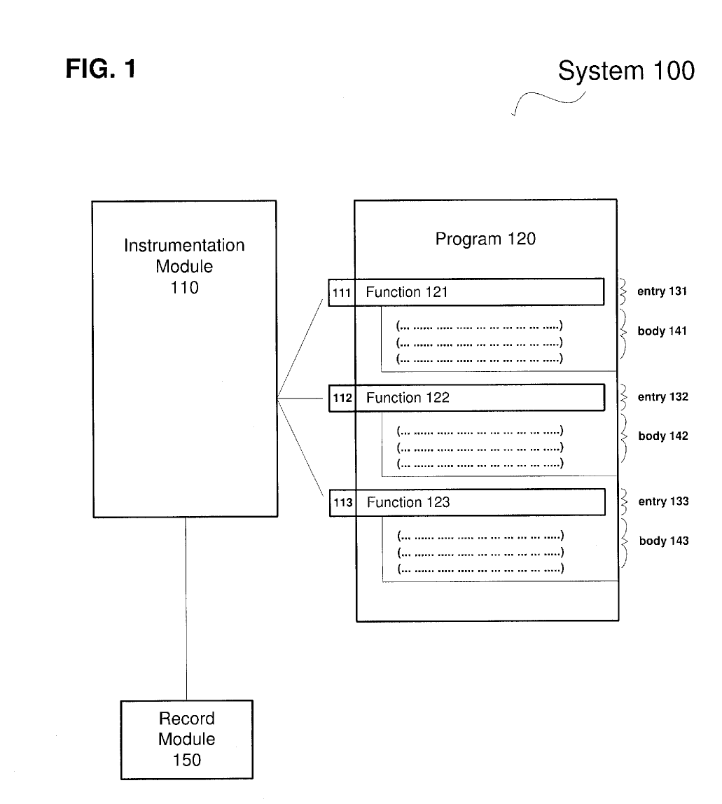

FIG. 1 shows an exemplary embodiment of a system 100 for providing a coverage analysis tool according to the exemplary embodiments of the present invention. The system 100 may include an instrumentation module 110 capable of performing dynamic instrumentation of code being executed in a program 120. It should be noted that a record module 150 (e.g., a database) may be coupled to the instrumentation module 110. Each instance where an instrumentation point is entered and removed from the program 120, that event may be recorded into the record module 150. Thus, the exemplary system 100 may keep track of the portions of code being executed within the program 120.

The program 120 may be written in any programming language (e.g., C/C++, Java, Assembly language, etc.), and may include a plurality of functions 121-123, wherein each of the functions 121-123 includes a function entry 131-133 and a function body 141-143. The functions 121-123 may be executable code defined by a sequence of instructions extending from an initial memory address to a final memory address. The function entries 131-133 may denote the beginning of the instructions for its respective functions 121-123 while the function bodies 141-143 are the structured block of code for its respective function 121-123. It should be noted that while the system 100 illustrated in FIG. 1 includes three instrumentation points 111-113, three functions 121-123 (each having a function entry 131-133 and a function body 141-143), these components are merely for illustrative purposes. Accordingly, any number of the instrumentation points and functions may be included within the exemplary system 100.

As illustrated, multiple instrumentation points 111-113 may be entered at each of the function entries 131-133 of the program 120. According to the exemplary embodiments of the present invention, the instrumentation points 111-113 may allow the instrumentation module 110 to dynamically instrument the functions 121-123 of the program 120. The instrumentation points 111-113 may be implemented in various manners. For example, the instrumentation points 111-113 may utilize a trap, or similar instruction, to enter an instrumentation handler (or an exception handler) into the program 120, wherein the instrumentation handler performs the required instrumentation procedure. Specifically, the instrumentation handler may include code that is called when the program executes any one of the instrumentation points. Alternatively, the instrumentation points 111-113 may utilize a call instruction that performs the required instrumentation procedure. It should be noted that architectures using a return address register (e.g., a link register (“LR”) on PowerPC, a return address (“RA”) on MIPS, etc.), the return address register may be preserved prior to issuing the call instruction. As a further alternative, instrumentation points 111-113 may implement the use of trap instructions and a trap handler, wherein the address of the current instrumentation point may be saved in order to simplify instrumentation. Accordingly, the exemplary systems and methods of the present invention may utilize any specific type of instrumentation point for coverage analysis, such as, but not limited to, trap instructions, call instructions, jump instructions, branch instructions, sensorpoints, or other mechanisms.

The instrumentation module 110 may serve to instrument (e.g., add instructions to) the functions 121-123 by inserting an instrumentation point into a conditional branch instruction of any one of the functions 121-123. Thus, the instrumentation module 110 may allow software developers and engineers to determine which segments of the code (e.g., which functions 121-123 within the program 120) have been executed. While each of the functions 121-123 may perform a wide variety of tasks, an exemplary embodiment of the present invention may provide for an editor that may be used to instrument the functions 121-123 while the program 120 is running on a deployed device in a field environment, without shutting down or rebooting the device with instrumented program 120. This may be extremely useful when shutting down or rebooting the device is undesirable or even impossible. Without impacting the operation of the device, editing the code of the functions 121-123 and the instrumentation points 111-113 within the source code (e.g., the program 120) may provide a coverage analysis tool that does not require the program 120 to be compiled in any special manner apart from how it will run in a live system.

Software applications, such as the program 120, may be created on a host computing device and ported to a target device. This type of development is typical for embedded devices. An embedded device is any device that includes a processor or microcontroller that executes program 120 to carry out desired functions. Normally, an embedded device has fewer resources than a general-purpose computer, such as having a slower processor, less memory (cache, RAM, Flash, etc.), etc. Examples of embedded devices include mobile phones, personal digital assistants, smart phones, smart process monitoring devices (e.g., thermostats, pressure sensors, flow sensors, etc.), etc. The exemplary embodiments of the present invention will be described with reference to a diagnostic tool for such embedded devices. However, those skilled in the art will understand that the present invention may be implemented in, for example, a diagnostic tool for software executing on any type of device.

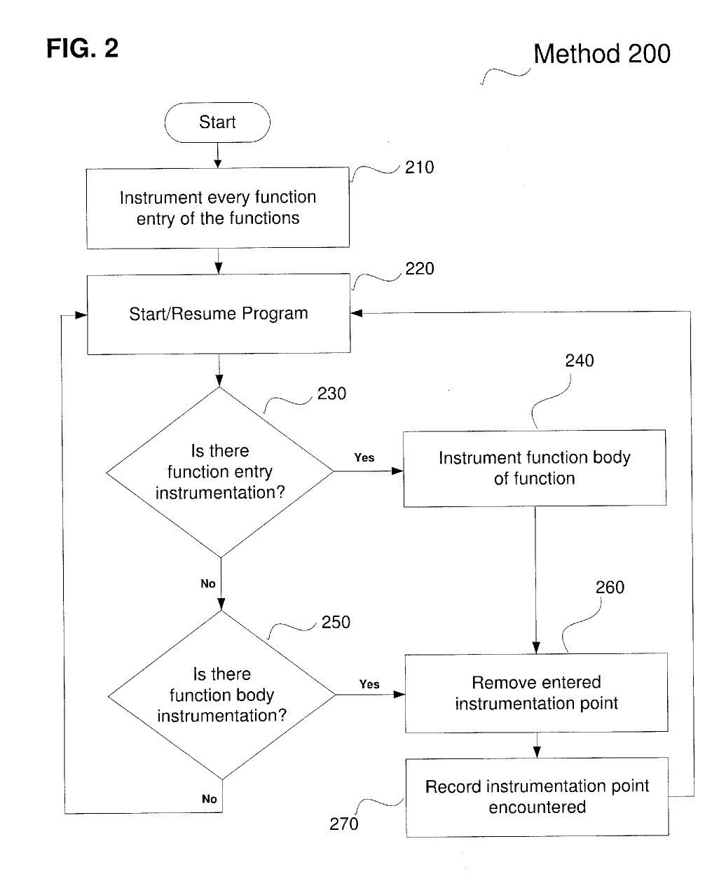

FIG. 2 shows an exemplary embodiment of a method 200 for providing a coverage analysis tool according to the exemplary embodiments of the present invention. As described above, the method 200 may allow for dynamic instrumentation of the program in order to keep track of which portions of code have been executed. In step 210, the method 200 may instrument each of the function entries 131-133. Specifically, the instrumentation points 111-113 may be placed at each of the function entries 131-133 of the respective functions 121-123. For example, each of the instrumentation points 111-113 may inserted into a conditional branch of its respective functions 121-123, wherein the instrumentation point may include a conditional branch instruction branching to an address of the program 120.

It should be noted that while the exemplary method 200 makes a distinction between function entry and function body, it is not necessary for the instrumentation to be performed at the function level. From a coverage analysis point of view, a function may not be very different from a conditionally executed block of code (“CEBC”). Both functions and CEBCs may have an entry and may contain conditional branches, thereby creating a further CEBC. Accordingly, the program code may be viewed as a flow chart having one or more initial entries. Once an entry is reached, the next CEBC entry in the flow chart may be instrumented. Thus, while the exemplary embodiments describe instrumentation being performed at the function level, the instrumentation of the present invention is not limited to being implemented at a function level, but may be implemented at any position within the program code. As described above, exemplary locations within a program may include the locations of conditional branches. Furthermore, those skilled in the art will understand that nested conditional branches need not be instrumented until the immediately enclosing conditional is reached. This can significantly reduce the number of concurrent instrumentation points in the program.

In step 220, the method 200 may start executing the program 120. It should be noted that while the step 220 may initially allow for the program to start execution, the step 220 may further allow for the program to resume execution following the removal of any entered instrumentation points or the determination of the absence of instrumentation points. In other words, the instrumentation of the program may be performed during runtime (e.g., continuous execution), the step 220 allows for the program to resume while verifying the presence of entered instrumentation points, at either one of the function entries 131-133 or one of the function bodies 141-143.

In step 230, the method 200 may determine if there is function entry instrumentation (e.g., function entry coverage analysis). Specifically, the method 200 may determine whether an instrumentation point (e.g., such as instrumentation point 111) has been encountered within a function entry (e.g., function entry 131) during the execution of the program 120. If an instrumentation point has been encountered, the method may then advance to step 240. If instrumentation point has not been encountered, the method may then advance to step 250.

In step 240, the method 200 may instrument the function bodies 141-143 within the respective functions 121-123. For example, if the instrumentation point 111 is encountered in a conditional branch of the function entry 131 during the step 230, then the rest of the function 121 (e.g., the function body 141 or CEBC of function 121) may be instrumented. Specifically, the instrumentation point 111 inserted into the conditional branch of the function 121 may allow for the function 121 to be instrumented by the instrumentation module 110. As described above, the instrumentation point 111 may utilize a trap instruction in order to enter an instrumentation handler (or an exception handler) to allow the instrumentation module 110 to perform the instrumentation. Alternatively, the instrumentation point 111 may utilize a call instruction, or any other mechanism, to the instrumentation module 110 to perform the required instrumentation. Once, the rest of the function 121 has been instrumented, the method 200 may advance to step 260. Thus, instrumentation may be performed in an incremental fashion during runtime, and only instrument the conditional branches with the function 121 when an instrumentation point is encountered.

It should be noted that the step 240 may be an optional step, depending on the format of the program code. As described above, the function entries 131-133 and the function bodies 141-143 are not necessarily distinct from each other. Accordingly, the rest of the function (e.g., the function body) may have been previously instrumented during step 210 of the method 200. In the alternative, the function body may not include any conditional branches. Thus, once a single instrumentation point of a function has been reached, it can be assumed that the remaining code of the function has been reached and there is no need to further instrument the function.

In step 250, the method 200 may determine if there is function body instrumentation (e.g., function entry coverage analysis). Specifically, the method 200 may determine whether an instrumentation point (e.g., such as instrumentation point 111) has been encountered within a function body (e.g., function body 141) during the execution of the program 120. If an instrumentation point has been encountered, the method may then advance to step 260. If instrumentation point has not been encountered, the method 200 may then return to step 220, where the program 120 resumes execution (e.g., control may be returned to the executable program 120 during runtime).

In step 260, the method 200 may remove the entered instrumentation point 111. Specifically, the instrumentation points, along with the inserted instrumentation may be removed from the program 120. Thus, once each instrumentation point 111-113 is encountered and instrumentation is performed, the extra instruction may be removed. Accordingly, the instrumentation points 111-113 may be executed once for each branch during the life of the program 120. As opposed to typical coverage analysis, wherein extra code (e.g., flags, patches, etc.) remain within a program, the exemplary method 200 eliminates the overhead associated with this extra code and may not require the program 120 to be compiled in an special manner apart from how it will execute in a live system (e.g., a target system).

It should be noted that in some instances the program 120 may need to be compiled in a slightly different manner in order to provide complete coverage analysis. For example, one of such instances may be when the processor architecture supports conditional instructions and the user wants to get full coverage details. According to this instance, it may be better from a performance point of view to compile the program without using conditional instruction. A further instance may be when the compiler does code path optimizations. According to this instance, full coverage information may not be calculated without disabling such optimizations. In addition, another reason to compile the program in a special way may be to include information about where to instrument the program and in which order. Therefore, it may be much faster than to determine that at runtime. Regardless of how the program 120 is compiled, these special “prepare for coverage analysis” compilation modes would have little or no impact on the performance of the program.

Furthermore, in step 270, the method 200 may record the fact that the instrumentation point 111 has been entered and removed. As described above, the record module 150 (e.g., a database) may be coupled to the instrumentation module 110. Thus, the record module 150 may reflect each instance where one of the instrumentation points 111-113 is encountered. The record within the record module 150 may be used to verify and assess the performance of the coverage analysis. Once the record module 150 has been updated, the method 200 may return to step 220 where the program 120 is resumed.

Following step 280, the method 200 may return to step 220, wherein the program 120 resumes execution. Accordingly, the entire method 200 may be repeated as additional instrumentation points (e.g., instrumentation points 112 and 113) are encountered during the execution of the program 120. Each of these instrumentation points 112 and 113 may lead to instrumentation of additional branch instructions within the respective functions 122 and 123. Furthermore, these instrumentation points 112 and 113 may be removed once the instrumentation module 110 has performed the instrumentation.

It should be noted that the exemplary instrumentation module 110 may include software development tools (e.g., such as workbench software, Wind River Scope-Tools, etc.) that may be used by the developer to create modify, and debug software programs such as program 120. The instrumentation module 110 may comprise a software suite that includes any number of individual software development programs, such as a compiler, a debugger, a configurator, a source code analyzer, a text editor, etc. These individual programs may either be run independently of a running application or within a main development program.

Furthermore, those skilled in the art will also understand that the above described exemplary embodiments may be implemented in any number of manners, including, as a separate software module, as a combination of hardware and software, etc. For example, instrumentation module 110 may be a program containing lines of code that, when compiled, may be executed on a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
inserting at least one instrumentation point into a program at a first location;
executing the program; and
removing the instrumentation point from the program when the executing program reaches the instrumentation point.

2. The method of claim 1, further comprising:
recording the at least one instrumentation point in a record when the instrumentation point is removed from the program.

3. The method of claim 1, wherein the first location is a function entry point within the program.

4. The method of claim 3, further comprising:
inserting a further instrumentation point at a second location within a function corresponding to the function entry point, wherein the inserting is performed without recompiling the program.

5. The method of claim 4, further comprising:
removing the further instrumentation point when the executing program reaches the further instrumentation point.

6. The method of claim 1, wherein the first location is a conditional branch of the program.

7. The method of claim 6, further comprising:
inserting a further instrumentation point at a second location within the program, wherein the inserting is performed without recompiling the program.

8. The method of claim 7, wherein the second location is a further conditional branch nested within the conditional branch.

9. The method of claim 7, further comprising:
removing the further instrumentation point when the executing program reaches the further instrumentation point.

10. A system, comprising:
an insertion module inserting at least one instrumentation point into a program at a first location;
an execution module executing the program; and
a removing module removing the instrumentation point when the executing program reaches the instrumentation point.

11. The system of claim 6, further comprising:
a recording module recording the at least one instrumentation point in a record when the instrumentation point is removed from the program.

12. The system of claim 10, wherein the first location is a function entry point within the program.

13. The system of claim 12, wherein the insertion module inserts a further instrumentation point at a second location within a function corresponding to the function entry point, wherein the inserting is performed without recompiling the program.

14. The system of claim 13, wherein the removing module removes the further instrumentation point when the executing program reaches the further instrumentation point.

15. The system of claim 10, wherein the first location is a conditional branch of the program.

16. The system of claim 15, wherein the insertion module inserts a further instrumentation point at a second location within the program, wherein the inserting is performed without recompiling the program.

17. The system of claim 16, wherein the second location is a further conditional branch nested within the conditional branch.

18. The system of claim 16, wherein the removing module removes the further instrumentation point when the executing program reaches the further instrumentation point.

19. A memory including a set of instructions executable by a processor, the set of instruction being operable to:
insert at least one instrumentation point into a program at a first location;
execute the program;
remove the instrumentation point from the program when the executing program reaches the instrumentation point; and
record the at least one instrumentation point in a record when the instrumentation point is removed from the program.

20. The memory of claim 19, wherein the first location is one of a function entry point and a conditional branch of the program.
